(19) United States
(12) Patent Application Publication
(10) Pub. No.: US 2017/0131809 A1
(43) Pub. Date: May 11, 2017

(54) TOUCH DISPLAY DEVICE AND MANUFACTURING METHOD THEREOF

(71) Applicant: Acer Incorporated, New Taipei City (TW)

(72) Inventors: Jia-Yu Lin, New Taipei City (TW); Jin-Ting Kuo, New Taipei City (TW)

(21) Appl. No.: 15/134,067

(22) Filed: Apr. 20, 2016

(30) Foreign Application Priority Data
Nov. 5, 2015 (TW) 104136408

(51) Int. Cl. G06F 3/044; G06F 1/16

(52) U.S. Cl. CPC G06F 3/044; G06F 1/1652; G06F 2203/04102; G06F 2203/04103

(57) ABSTRACT

A touch display device and a manufacturing method thereof are provided. The touch display device includes a flexible touch display panel, a plurality of first pads, a plurality of touch electrodes and a plurality of conducting wires. The flexible touch display panel includes a first bending area bending along a first bending axis. The first pads are disposed on the flexible touch display. The touch electrodes are disposed on the flexible touch display. The conducting wires are disposed on the flexible touch display. A plurality of first terminals of the conducting wires is electrically coupled to the touch electrodes respectively, and a plurality of second terminals of the conducting wires is electrically coupled to the first pads respectively. Conducting wires having a direction different from the axial direction of the first bending axis are not disposed in the first bending area of the flexible touch display panel.

### CROSS-REFERENCE TO RELATED APPLICATION

This application claims the priority benefit of Taiwan application serial no. 104136408, filed on Nov. 5, 2015. The entirety of the above-mentioned patent application is hereby incorporated by reference herein and made a part of this specification.

### BACKGROUND OF THE INVENTION

Field of the Invention

The invention relates to an electronic device; more particularly, the invention relates to a touch display device and a manufacturing method thereof.

Description of Related Art

Transparent conductive films (e.g. indium tin oxide, abbreviated as ITO) materials can be used in various flexible electronic products such as electronic book flexible mobile phones, flexible displays, disposable electronic products, wearable or mounted products. Flexible electronics technology allows electrical products to be soft and flexible, realizing features such as being lightweight, thin, short, and small, such that they meet the demands of being user-friendliness and convenience.

FIG. 1 is a circuit schematic diagram illustrating a known touch display device. FIG. 2 is a schematic diagram illustrating a bent touch display device of FIG. 1. Referring to FIGS. 1 and 2. The known touch display device 100 includes a flexible touch display panel 110, pads 111, touch electrodes 115, conducting wires 116, and a flexible circuit board 120. Here, the first pads 111, the touch electrodes 115, and the conducting wires 116 are disposed on the flexible touch display panel 110. First terminals of the conducting wires 116 are electrically coupled to the touch electrodes 115 respectively, and second terminals of the conducting wires 116 are electrically coupled to the first pads 111 respectively. The flexible circuit board 120 has second pads 122, and the second pads 122 are soldered to the first pads 111. Here, the second pads 122 may be electrically coupled to a control circuit 150 through conducting wires of the flexible circuit board 120 (the control circuit 150 may be, for instance, a printed circuit board). Accordingly, touch signals of the touch electrodes 115 of the flexible touch display panel 110 can be transmitted to the second pads 122 of the flexible circuit board 120 through the conducting wires 116 and the first pads 111, and then the flexible circuit board 120 transmits the control signal to the control circuit 150.

However, in order to meet the demand of low impedance, the conducting wires 116 of the flexible touch display panel 110 may be highly conductive metal materials such as copper and silver. The known flexible touch display panel 110 has a first bending area 110B1. In the bending area 110B1, the flexible touch display panel 110 is bent along a bending axis P. In the known touch display device 100, the conducting wires 116 may go through the first bending area 110B1 of the flexible touch display panel 110. When the flexible touch display panel 110 is bent in the bending area 110B1, the conducting wires 116 in the bending area 110B1 are simultaneously bent. After repeated bending, some of the conducting wires 116 in the bending area 110B1 may break down due to repeated bending, such that the conducting wires can no longer effectively transmit signal.

### SUMMARY OF THE INVENTION

The invention is directed to a touch display device and a manufacturing method thereof. The touch display device can prevent damage to the conducting wires disposed on the flexible touch display panel when the flexible touch display panel is bent.

The invention provides a touch display device including a flexible touch display panel, first pads, touch electrodes, and conducting wires. The flexible touch display panel includes a first bending area so as to be bent along a first bending axis. The first pads are disposed on the flexible touch display panel. The touch electrodes are disposed on the flexible touch display panel to sense a touch event of the flexible touch display panel. The conducting wires are disposed on the flexible touch display. First terminals of the conducting wires are electrically coupled to the touch electrodes respectively, and second terminals of the conducting wires are electrically coupled to the first pads respectively. Conducting wire having a direction different from the axial direction of the first bending axis is not disposed in the first bending area of the flexible touch display panel.

The invention provides a touch display device including a flexible touch display panel and a flexible circuit board. The flexible touch display panel has first pads, touch electrodes, and conducting wires disposed on the flexible touch display panel. The touch electrodes are configured to sense a touch event of the flexible touch display panel. First terminals of the conducting wires are electrically coupled to the touch electrodes respectively, and second terminals of the conducting wires are electrically coupled to the first pads respectively. The flexible circuit board has second pads, transmission conducting wires, and third pads disposed on the flexible circuit board. At least a portion of the flexible circuit board is stacked on the flexible touch display panel to electrically couple the second pads of the flexible circuit board to the first pads of the flexible touch display panel respectively. The transmission conducting wires are disposed in a wiring area of the flexible circuit board. The first terminals of the transmission conducting wires are electrically coupled to the second pads respectively, and the second terminals of the transmission conducting wires are electrically coupled to the third pads respectively. The wiring area of the flexible circuit board is stacked on the flexible touch display panel.

The manufacturing method of touch display device includes: disposing first pads on a flexible touch display panel, wherein the flexible touch display panel has a first bending area bending along a first bending axis; disposing touch electrodes on the flexible touch display panel to sense a touch event of the flexible touch display panel; disposing conducting wires on the flexible touch display panel, wherein the first terminals of the conducting wires are electrically coupled to the touch electrodes respectively, and the second terminals of the conducting wires are electrically coupled to the first pads respectively, wherein any conducting wire having direction different from the axial direction of the first bending axis is not disposed in the first bending area of the flexible touch display panel.

The manufacturing method of touch display device includes: disposing first pads on a flexible touch display panel; disposing touch electrodes on the flexible touch display panel to sense a touch event of the flexible touch display panel; disposing conducting wires on the flexible touch display panel. First terminals of the conducting wires are electrically coupled to the touch electrodes respectively, and second terminals of the conducting wires are electrically coupled to the first pads respectively. Here the flexible circuit board has second pads, transmission conducting wires, and third pads. The transmission conducting wires are disposed in a wiring area of the flexible circuit board. The first terminals of the transmission conducting wires are electrically coupled to the second pads respectively, and the second terminals of the transmission conducting wires are electrically coupled to the third pads respectively. The wiring area of the flexible circuit board is stacked on the flexible touch display panel to electrically couple the second pads of the flexible circuit board to the first pads of the flexible touch display panel respectively.

Based on the above, to prevent damage to the conducting wires due to bending, any conducting wire having a direction different from the axial direction of the bending axis is not disposed in the bending area of the flexible touch display panel. Accordingly, in the embodiments of the invention the life of conducting wires disposed in the flexible touch display panel is increased and effective signal transmission in the touch display device is maintained. Moreover, in the embodiments of the invention, the design space of the touch display device is improved by adding functions to the touch display device through coupling designs between the flexible circuit board and the flexible touch display panel, or by adding a sensor in the bending area of the flexible circuit board.

The following embodiments and figures illustrate the above-described features. To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a known touch display device.

FIG. 2 is a schematic diagram illustrating a touch display device of FIG. 1 bent.

FIG. 3 is a schematic diagram illustrating a touch display device according to an embodiment.

FIG. 4 is a schematic diagram illustrating a touch display device according to another embodiment.

FIG. 5 is a schematic diagram illustrating a touch display device according to an embodiment.

FIG. 6 is a schematic diagram illustrating a touch display device according to an embodiment.

FIG. 7 is a schematic diagram illustrating a touch display device according to another embodiment.

FIG. 8 is a schematic diagram illustrating a touch display device according to an embodiment.

FIG. 9 is a schematic diagram illustrating a touch display device according to another embodiment.

FIG. 10 is a schematic diagram illustrating a touch display device according to an embodiment.

FIG. 11 illustrates a flexible circuit boards coupled to a flexible touch display panel via face-to-face bonding.

FIG. 12 illustrates that the flexible circuit boards is coupled to the flexible touch display panel via a back-to-back bonding.

FIG. 13 is a schematic diagram illustrating a touch display device according to an embodiment.

FIG. 14 illustrates a case of a bent flexible touch display device according to FIG. 13.

FIG. 15 is a flowchart of manufacturing method of touch display device illustrating a touch display device according to an embodiment.

FIG. 16 is manufacturing method flowchart illustrating a manufacturing method for touch display device according to another embodiment.

### DESCRIPTION OF THE EMBODIMENTS

Reference will now be made in detail to the present preferred embodiments of the invention, instances of which are illustrated in the accompanying drawings. Wherever possible, the same reference numbers are used in the drawings and the description to refer to the same or like parts.

The word “couple” (or connect) in the description and claims may refer to any direct or indirect connection. For instance, in the description and claims, if first pads are coupled to (or connected to) second pads, it means that the first pads may be directly connected to the second pads or may be indirectly connected to the second pads through another device, wire, or other connection means. Moreover, elements/components/steps with the same reference numerals represent the same or similar parts in the drawings and embodiments. The descriptions of the same elements/components/steps in an embodiment of the invention may be applied to the descriptions of the same elements/components/steps in another embodiment.

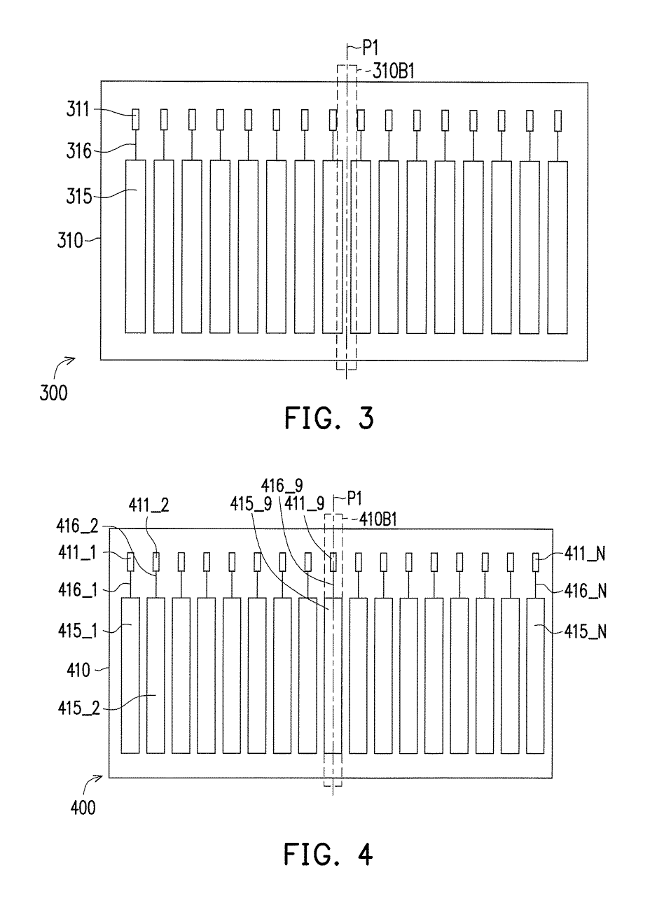

FIG. 3 is a schematic diagram illustrating a touch display device according to an embodiment. In the present embodiment, a touch display device 300 includes a flexible touch display panel 310, first pads 311, touch electrodes 315, and conducting wires 316. Here the first pads 311, the touch electrodes 315 and the conducting wires 316 are respectively disposed on the flexible touch display panel 310. The touch electrodes 315 are configured to sense a touch event of the flexible touch display panel 310. First terminals of the conducting wires 316 are electrically coupled to the touch electrodes 315 respectively, and second terminals of the conducting wires 316 are electrically coupled to the first pads 311 respectively. Accordingly, touch signals of the touch electrodes 315 of the flexible touch display panel 310 can be transmitted to the first pads 311 through the conducting wires 316.

The flexible touch display panel 310 has a first bending area 310B1. The flexible touch display panel 310 can be bent in the bending area 310B1 along a first bending axis P1 (FIG. 2 illustrates a case of a bent flexible touch display panel 310) However, to prevent the conducting wires 316 from bending, the first pads 311 or the conducting wires 316 are not disposed in the first bending area 310B1. Accordingly, damage to the conducting wires 316 due to bending of the flexible touch display panel 310 can be prevented when the flexible touch display panel 310 is bent in the bending area 310B1 along the first bending axis P1.

Referring to FIG. 4 for another embodiment of the invention. FIG. 4 is a schematic diagram illustrating a touch display device according to another embodiment. A touch display device 400 includes a flexible touch display panel 410, first pads (e.g. 411_1, 411_2 . . . 411_9 . . . 411_N as shown in FIG. 4), touch electrodes (e.g. 415_1, 415_2, 415_9 . . . 415_N as shown in FIG. 4), and conducting wires (e.g. 416_1, 416_2 . . . 415_9 . . . 415_N as shown in FIG. 4), wherein N is a whole number greater than 1. The first pads 411_1 to 411_N, the touch electrodes 415_1 to 415_N, and the conducting wires 416_1 to 416_N are respectively disposed on the flexible touch display panel 410. In the present embodiment, the flexible touch display panel 410 has a first bending area 410B1 bending along a first bending axis P1 (FIG. 2 illustrates a case of a bent flexible touch display panel 410). In the present embodiment, a touch electrode 415_9 is disposed in the first bending area 410B1. To prevent the conducting wires from being bending, a first pad 411_9 and a conducting wire 416_9 having substantially identical a direction as the bending axis P1 are disposed in the first bending area 410B1. In other words, any conducting wire having a direction different from the axial direction of the first bending axis P1 is not disposed in the first bending area 410B1 of the flexible touch display panel 410. Accordingly, damage to the conducting wire 416_9 disposed in the first bending area 410B1 due to bending of the flexible touch display panel 410 can be prevented when the flexible touch display panel 410 is bent in the bending area 310B1 along the first bending axis P1.

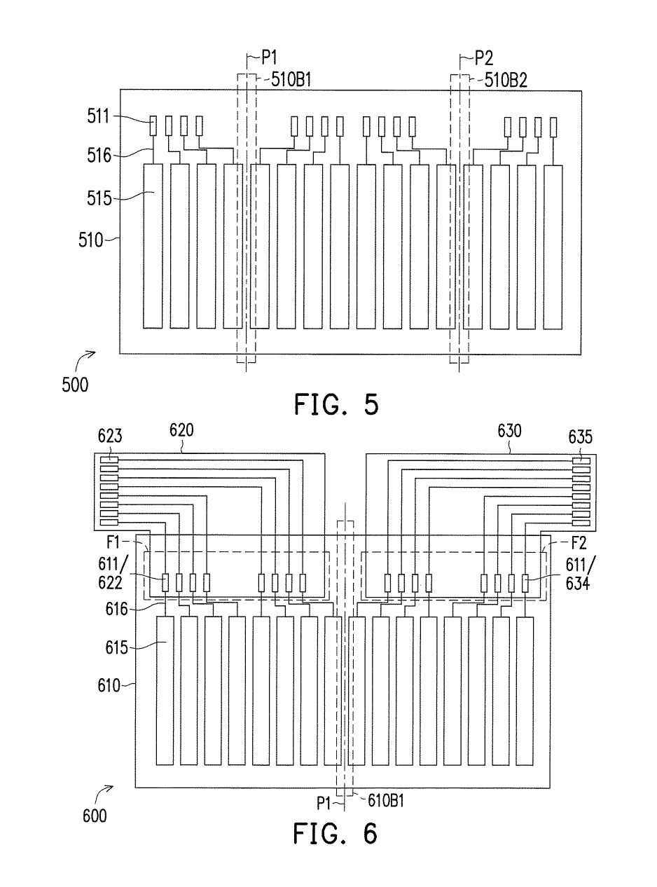

FIG. 5 is a schematic diagram illustrating a touch display device according to an embodiment. In the present embodiment, a touch display device 500 includes a flexible touch display panel 510, first pads 511, touch electrodes 515, and conducting wires 516. The first pads 511, the touch electrodes 515, and the conducting wires 516 are respectively disposed on the flexible touch display panel 510.

In the present embodiment, the flexible touch display panel 510 has a first bending area 510B1 which can be bent along a first bending axis P1, and a second bending area 510B2 bending along a second bending axis P2. Here, the flexible touch display panel 510 can be bent in the first bending area 510B1 along the first bending axis P1 and in the second area 510B2 along the second bending axis P2. However, to prevent the conducting wires 516 from being bent, the first pads 511 or the conducting wires 516 are not disposed in the first bending area 510B1 or the bending area 510B2. Accordingly, when the flexible touch display panel 510 is bent in the first bending area 510B1 along the first bending axis P1, or when the flexible touch display panel 510 is bent in the second bending area 510B2 along the second bending axis P2, damage to the conducting wires 516 due to the flexible touch display panel 510 being bent can be prevented. In other words, the flexible touch display panel 510 can have repeated bending areas at the same time without disposing conducting wires or disposing conducting wires having a direction different from the axial direction of the bending axis in the bending areas. In addition, in the present embodiment, the number of bending areas is not limited to the above embodiments. The number of bending areas can be defined based on different design needs and determined according to the embodiments above to prevent damage to the conducting wires due to bending of the flexible touch display panel.

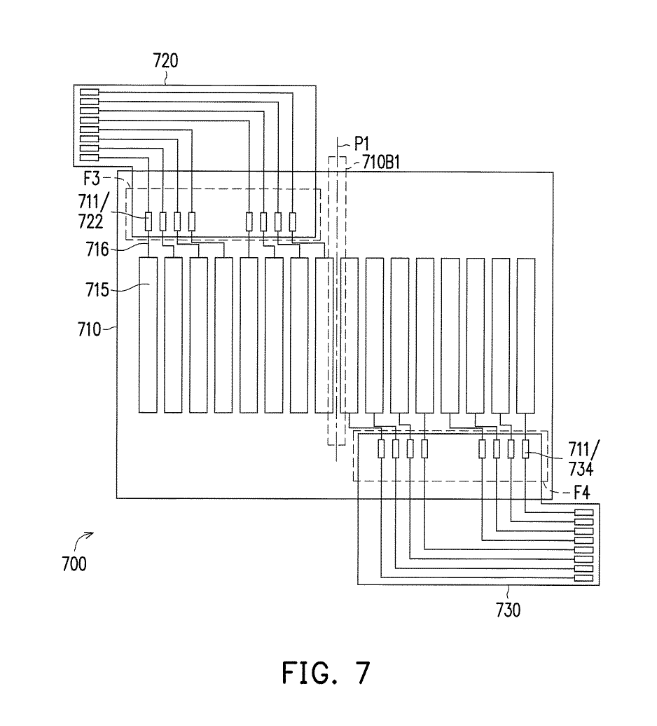

FIG. 6 is a schematic diagram illustrating a touch display device according to an embodiment. A touch display device 600 includes a flexible touch display panel 610, first pads 611, touch electrodes 615 and conducting wires 616. The flexible touch display panel 610 has a first bending area 610B1 which bending along a first bending axis P1 (FIG. 2 illustrates a case of a bent flexible touch display panel 610).

In the present embodiment, the flexible touch display panel 610 further includes flexible circuit boards 620 and 630 disposed at a same side of the touch display device 610. Here, the first flexible circuit boards 620 and 630 do not cross the first bending area 610B1 of the flexible touch display panel 610. The flexible circuit board 620 has second pads 622 and third pads 623, and the third pads 623 are electrically coupled to the second pads 622 through transmission conducting wires of the flexible circuit board 620. The flexible circuit board 630 has fourth pads 634 and fifth pads 635, and the fifth pads 635 are electrically coupled to the fourth pads 634 through transmission conducting wires of the flexible circuit board 630. At least a portion of the flexible circuit board 620 is stacked on the flexible touch display panel 610 to further electrically couple the second pads 622 of the flexible circuit board 620 to a first pads group F1 of the first pads 611 of the flexible touch display panel 610 respectively. At least a portion of the flexible circuit board 630 is stacked on the flexible touch display panel 610 to further electrically couple the fourth pads 634 of the flexible circuit board 630 to a second pads group F2 of the first pads 611 of the flexible touch display panel respectively.

In other words, no conducting wire is disposed in the first bending area 610B1. The touch display device 600 uses the flexible circuit boards 620 and 630 to electrically couple the first pads group F1 of the first pads 611 and the second pads group F2 of the second pads 622 respectively. Accordingly, the touch electrodes 615 of the flexible touch display panel 610 can be electrically coupled to external control circuits (not shown) through the third pads 623 and the fifth pads 635 of the flexible circuit boards 620 and 630, and prevent the conducting wires 616 from being damaged by bending of the flexible touch display panel 610.

Referring to FIG. 7 for another embodiment of the invention. FIG. 7 is a schematic diagram illustrating a touch display device according to another embodiment. A touch display device 700 includes a flexible touch display panel 710 and flexible circuit boards 720 and 730. The flexible touch display panel 710 includes first pads 711, touch electrodes 715, and conducting wires 716. The first pads 711, the touch electrodes 715, and the conducting wires 716 are respectively disposed on the flexible touch display panel 710. The flexible touch display panel 710 has a first bending area 710B1 which can be bent along a first bending axis P1 (FIG. 2 illustrates a case of a bent flexible touch display panel 710). Refer to the flexible touch display panel 310, the first bending area 310B1, the first pads 311, the touch electrodes 315, and the conducting wires 316 of FIG. 3 for related explanations for the flexible touch display panel 710, the first bending area 710B1, the first pads 711, the touch electrodes 715, and the conducting wires 716 of FIG. 7.

In the present embodiment, the flexible circuit boards 720 and 730 are disposed at opposite sides (i.e. a first side and a second side) on the flexible touch display panel 710, and the flexible circuit boards 720 and 730 do not cross the first bending area 710B1. Here, a first pads group F3 and a second pads group F4 of the first pads 711 are disposed on the flexible touch display panel 710 at the first and second sides respectively. At least a portion of the flexible circuit board 720 is stacked on the flexible touch display panel 710 to further electrically couple the second pads 722 of the flexible circuit board 720 to the first pads group F3 of the first pads 711 of the flexible touch display panel 710 respectively. At least a portion of the flexible circuit board 730 is stacked on the flexible touch display panel 710 to electrically couple the fourth pads 734 of the flexible circuit board 730 to the second pads group F4 of the first pads 711 of the flexible touch display panel 710 respectively. Refer to the flexible circuit boards 620 and 630 of FIG. 6 for detailed explanations of the flexible circuit boards 720 and 730 of FIG. 7. Touch signal of the touch electrodes 715 of the flexible touch display panel 710 is transmitted to identical or different external control circuits (not shown) through the flexible circuit boards 710 and 720.

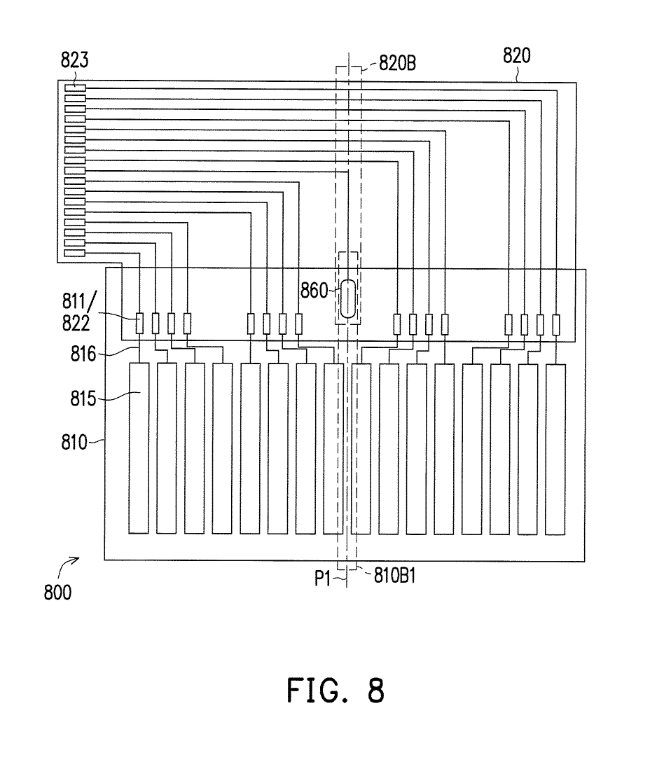

FIG. 8 is another schematic diagram illustrating a touch display device according to an embodiment. In the present embodiment, a touch display device 800 includes a flexible touch display panel 810 and flexible circuit boards 810 and 820. The flexible touch display panel 810 includes first pads 811, touch electrodes 815, and conducting wires 816. The flexible touch display panel 810 has a first bending area 810B1 bending along a first bending axis P1 (FIG. 2 illustrates a case of a bent flexible touch display panel 810). Refer to the flexible touch display panel 310, the first bending area 310B1, the first pads 311, the touch electrodes 315, and the conducting wires 316 of FIG. 3 for related explanations for the flexible touch display panel 810, the first bending area 810B1, the first pads 811, the touch electrodes 815, and the conducting wires 816 of FIG. 8.

The flexible circuit board 820 has second pads 822 and third pads 823, and the third pads 823 are electrically coupled to the second pads 822 through transmission conducting wires of the flexible circuit board 820. The third pads 823 are configured to electrically couple to an external control circuit (not shown). At least a portion of the flexible circuit board 820 is stacked on the flexible touch display panel 810 to electrically couple the second pads 822 of the flexible circuit board 820 to the first pads 811 of the flexible touch display panel 810. The flexible circuit board 820 provides a signal transmission path between each of the touch electrodes 815 of the flexible touch display panel 810 and the external control circuits (not shown). In the present embodiment, the flexible circuit board 820 crosses the bending area 810B1 of the flexible touch display panel 810, and the flexible circuit board 820 has a bending area 820B. At least a portion of the bending area 820B of the first flexible circuit boards 820 is stacked on the bending area 810B1 of the flexible touch display panel 810. When the flexible touch display panel 810 is bent along the first bending axis P1, the bending area 820B of the flexible circuit board 820 is simultaneously bent along the first bending axis P1 of the flexible touch display panel 810. When the flexible touch display panel 810 is bent in the bending area 810B1 along the bending axis P1, according to the present embodiment, damage to the conducting wires 816 due to bending of the flexible touch display panel 810 is prevented.

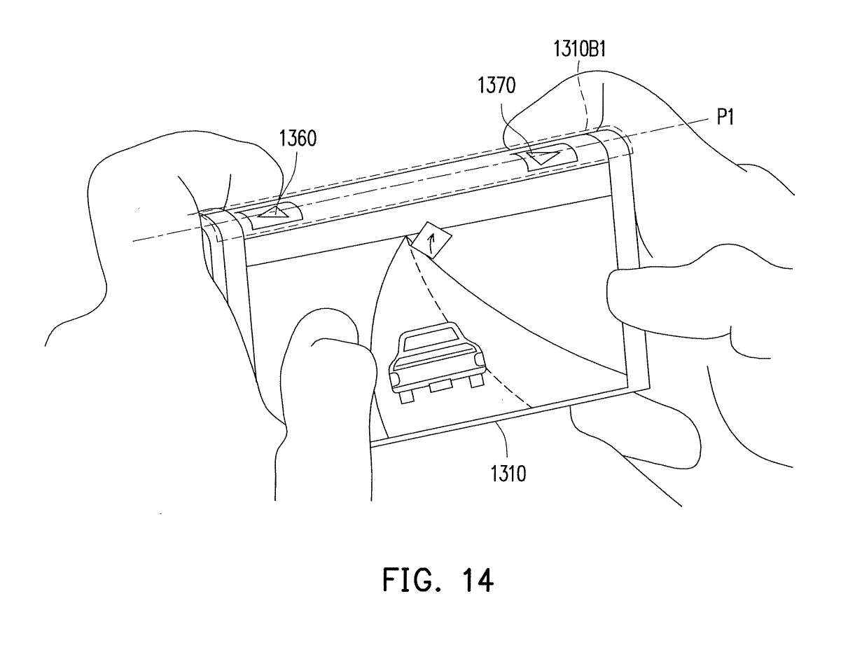

In addition, in the present embodiment, a sensor 860 is further disposed in the bending area 820B of the flexible circuit board 820 and is electrically coupled to the third pads 823. The sensor 860 is configured to provide a sensing function and transmit results to the control circuit (not shown) through the third pads 823. For instance, the sensor 860 may be a force sensor, a touch sensor, or a light sensor, etc. As a result, when the flexible touch display panel 810 is bent in the bending area 810B1, the sensor 860 provides functions such as sensing changes in pressure, touch, or light at a side area of the touch display device 800 (FIG. 14 illustrates a scenario of the sensor 860 and the flexible touch display panel 810 being bent).

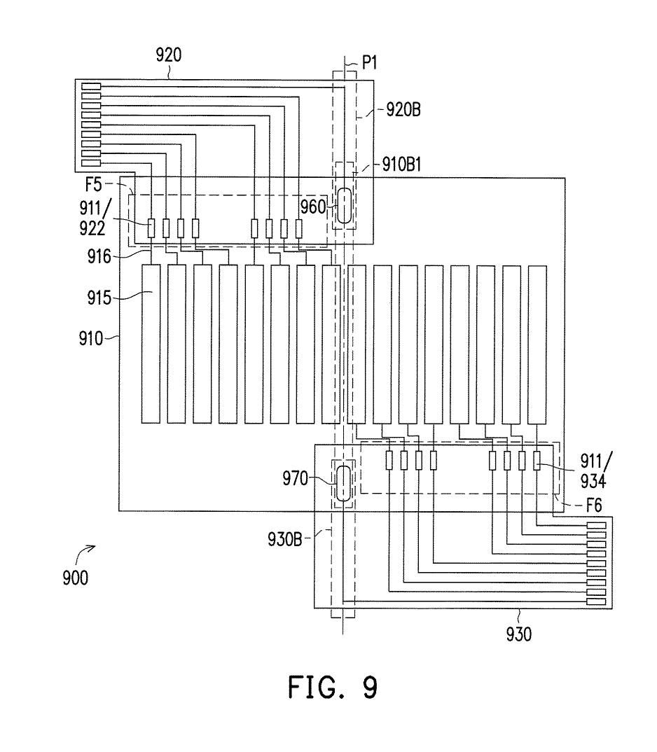

Referring to FIG. 9 for another embodiment of the invention. FIG. 9 is a schematic diagram illustrating a touch display device according to another embodiment. A touch display device 900 includes a flexible touch display panel 910 and flexible circuit boards 920 and 930. The flexible touch display panel 910 includes first pads 911, touch electrodes 915, and conducting wires 916. The first pads 911, the touch electrodes 915, and the conducting wires 916 are respectively disposed on the flexible touch display panel 910. The flexible touch display panel 910 has a first bending area 910B1 which can be bent along a first bending axis P1 (FIG. 2 illustrates a case of a bent flexible touch display panel 910). Here, a first pads group F5 and a second pads group F6 of the first pads 911 disposed on the flexible touch display panel 910 are disposed at a first side and a second side respectively. Refer to the flexible touch display panel 710, the first bending area 710B1, the first pads 711, the touch electrodes 715, the first pads group F3, the second pads group F4, and the conducting wires 716 of FIG. 7 for related explanations for the flexible touch display panel 910, the first bending area 910B1, the first pads 911, the touch electrodes 915, the first pads group F5, the second pad group F6, and the conducting wires 916 of FIG. 9.

In the present embodiment, the flexible circuit boards 920, 930 are disposed at different sides of the flexible touch display panel 910 respectively (a first side and a second side). At least a portion of the flexible circuit board 920 is stacked on the flexible touch display panel 910 to electrically couple the second pads 922 of the flexible circuit board 920 to the first pads group F5 of the first pads 911 of the flexible touch display panel 910 respectively. At least a portion of the flexible circuit board 930 is stacked on the flexible touch display panel 910 to electrically couple the fourth pads 934 of the flexible circuit board 930 to the second pads group F6 of the first pads 911 of the flexible touch display panel 910 respectively. Refer to the related explanations of the flexible circuit boards 620 and 630 of FIG. 6 or the flexible circuit board 820 of FIG. 8 for detailed explanations of the flexible circuit boards 920 and 930 of FIG. 9.

Here, the first flexible circuit boards 920 and 930 each respectively cross the first bending area 910B1 of the flexible touch display panel 910. At least a portion of the bending area 920B of the flexible circuit board 920 and a portion of the bending area 930B of the flexible circuit boards 930 are stacked on the first bending area 910B1 of the flexible touch display panel 910. Accordingly, when the flexible touch display panel 910 is bent in the first bending area 910B1, the bending areas 920B and 930B of the flexible circuit boards 920 and 930 are simultaneously bent along the first bending axis P1 of the flexible touch display panel 910. In the present embodiment, two sensors 960 and 970 are further disposed in the bending areas 920B and 930B of the flexible circuit boards 920 and 930. Detailed explanations of the sensors 960 and 970 of FIG. 9 can be deduced from the descriptions provided in FIG. 8 regarding the sensor 860. When the flexible touch display panel 910 is bent in the bending area 910B1, the sensors 960 and 970 can provide sensing functions at a side area of the bent touch display device 900, and transmit the results to the control circuit through the pads (not shown). FIG. 14 illustrates a scenario of the sensors 960 and 970 and the flexible touch display panel 910 being bent.

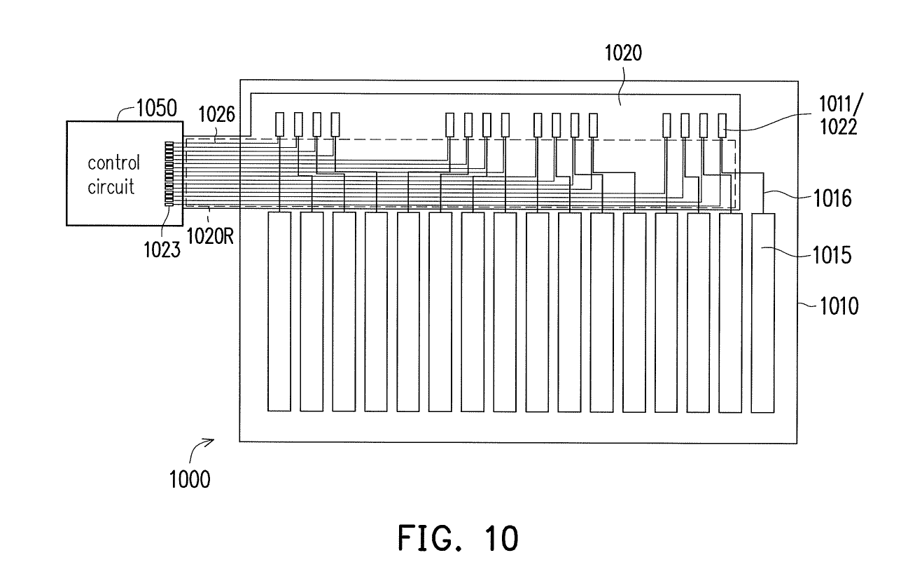

FIG. 10 is a schematic diagram illustrating a touch display device according to an embodiment. In the present embodiment, a touch display device 1000 includes a flexible touch display panel 1010 and flexible circuit board 1020. The flexible touch display panel 1010 includes first pads 1011, touch electrodes 1015, and conducting wires 1016. Here, the flexible circuit board 1020 has second pads 1022, third pads 1023, and transmission conducting wires 1026. The transmission conducting wires 1026 are disposed in a wiring area 1020R of the flexible circuit board 1020. First terminals of the transmission conducting wires 1026 of the flexible circuit board 1020 are electrically coupled to the second pads 1022 of the flexible circuit board 1020. Second terminals of the transmission conducting wires 1026 of the flexible circuit board 1020 are electrically coupled to the third pads 1023 of the flexible circuit board 1020. The third pads 1023 of the flexible circuit board 1020 are configured to electrically couple a control circuit 1050. Here, at least a portion of the wiring area 1020R of the transmission conducting wires 1026 of the flexible circuit board 1020 is stacked on the conducting wires 1016 of the flexible touch display panel 1010.

In other words, in the present embodiment, the flexible circuit board 1020 is electrically coupled to the flexible touch display 1010 via a back-to-back bonding, such that the wiring area 1020R of the flexible circuit board 1020 and the location that the conducting wires 1016 are disposed on the flexible touch display panel 1010 are overlapped. Therefore, the space of the flexible circuit board 1020 in which the portion of the flexible circuit board 1020 outside of the flexible touch display panel 1010 is disposed can be reduced. Depending on the design needs, an anti-magnetic layer (not shown; refer to the anti-magnetic layer 1220C in FIG. 12) may be optionally disposed between the flexible circuit board 1020 and the flexible touch display panel 1010.

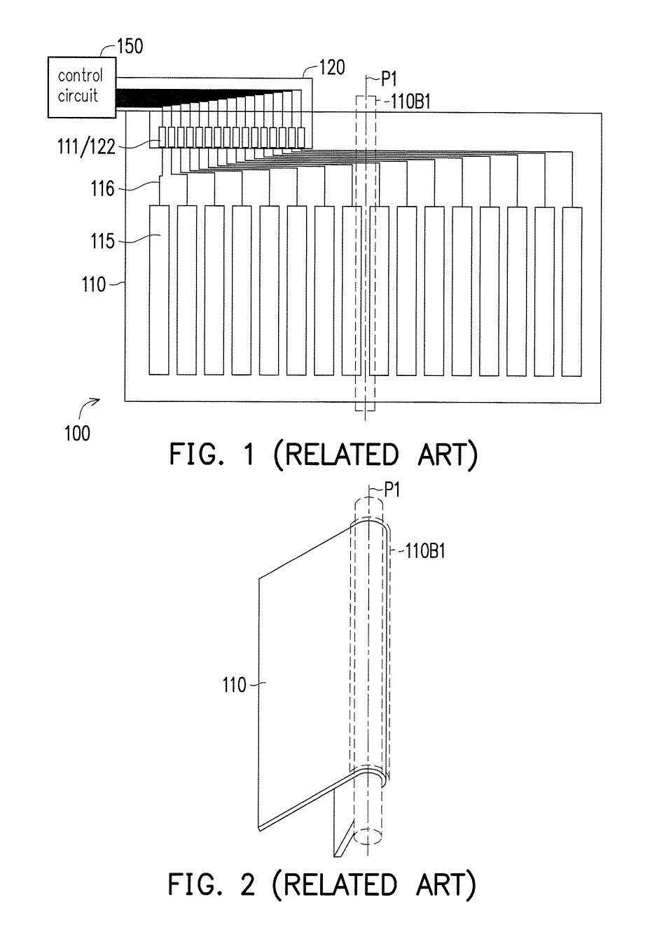

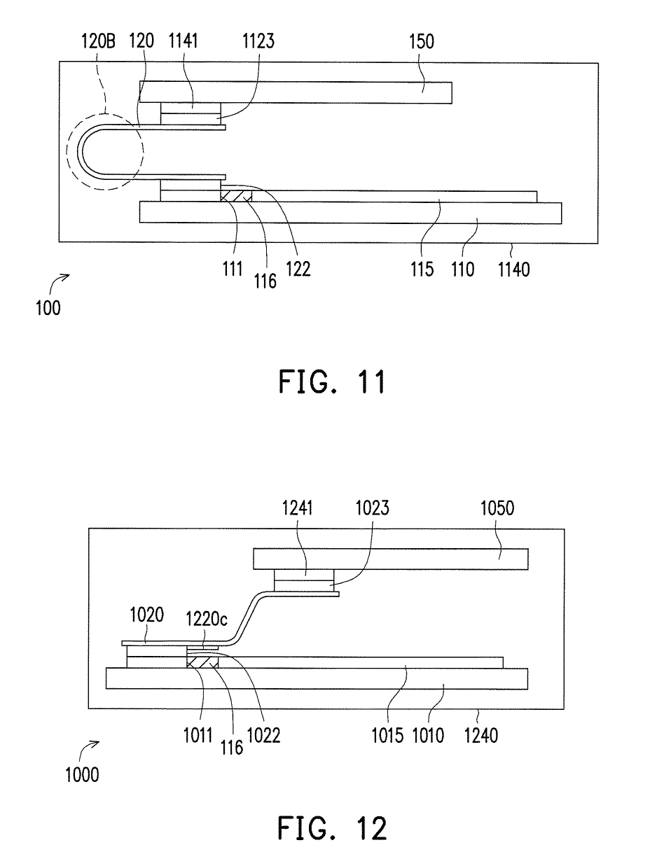

More particularly, referring to FIG. 11. FIG. 11 illustrates the flexible circuit board 120 in FIG. 1 is coupled to the flexible touch display panel 110 via a face-to-face bonding. Referring to FIG. 1 and FIG. 11. In the present embodiment, the flexible touch display panel 110 of a touch display device 100, the flexible circuit board 120, the control circuit 150 (e.g. a printed circuit board) are disposed in a housing 1140. The flexible circuit board 120 is coupled to the flexible touch display panel 110 via a face-to-face bonding, such that second pads 122 of the flexible circuit board 120 are electrically coupled to first pads 111 of the flexible touch display panel 110. The second pads 122 of the flexible circuit board 120 are electrically coupled to third pads 1123 of the flexible circuit board 120 through transmission conducting wires of the flexible circuit board 120. The third pads 1123 of the flexible circuit board 120 are electrically coupled to pads 1141 of the control circuit 150. Accordingly, touch signals of the touch electrodes 110 can be transmitted to the control circuit 150 through the flexible circuit board 120. As shown in FIG. 1, based on the disposition method of face-to-face bonding of the present embodiment, the wiring area of the flexible circuit board 120 (i.e. the wiring area for the transmission conducting wires of the flexible circuit board 120) is not stacked on the conducting wires 116 of the flexible touch display panel 110. After disposing the flexible touch display panel 110, the flexible circuit board 120, and the control circuit 150 in the housing 1140, the flexible circuit board 120 is bent, such that the control circuit 150 is stacked on the flexible touch display panel 110 (e.g. stacked on the back of the flexible touch display panel 110 as shown in FIG. 11). At this time, the bending area 120B of the flexible circuit board 120 is outside the edge of the flexible touch display panel. Accordingly, the flexible circuit board 120 takes up extra space in the housing 1140.

Referring to FIG. 12. FIG. 12 illustrates the flexible circuit board 1020 being coupled to the flexible touch display panel 1010 via a back-to-back bonding in FIG. 10. Referring to FIG. 10 and FIG. 12. In the present embodiment, a flexible touch display panel 1010, a flexible circuit board 1020, and a control circuit 1050 (e.g. a printed circuit board) of the touch display device 1000 are disposed in a housing 1240. The flexible circuit board 1020 is coupled to the flexible touch display panel 1010 via a back-to-back bonding, such that second pads 1022 of the flexible circuit board 1020 are electrically coupled to first pads 1011 of the flexible touch display panel 1010. Second terminals 1022 of the flexible circuit board 1020 are electrically coupled to third pads 1023 of the flexible circuit board 1020 through transmission conducting wires 1026 of the flexible circuit board 1020. The third pads 1023 of the flexible circuit board 1020 are electrically coupled to pads 1241 of a control circuit 1050. Accordingly, touch signals of the touch electrodes 1010 can be transmitted to the control circuit 1050 through the flexible circuit board 1020. As shown in FIGS. 10 and 12, based on the back-to-back bonding disposition method of the present embodiment, the wiring area 1020R of the flexible circuit board 1020 is stacked on the conducting wires 1016 of the flexible touch display panel 1010. Moreover, in the present embodiment, an anti-magnetic layer 1220C is disposed between the wiring area 1020R of the flexible circuit board 1020 and the conducting wires 1016 of the flexible touch display panel 1010, so as to prevent electromagnetic interference between the wiring area 1020R of the flexible circuit board 1020 and the conducting wires 1016 of the flexible touch display panel 1010.

In other words, in comparison to the face-to-face bonding of the touch display device in the embodiment of FIG. 11, the embodiment of FIG. 12 reduces the space for disposition of the flexible circuit board 1020 in the housing 1240 via the back-to-back disposition method to more efficiently utilize or design the space, structure, or size of the touch display device, so as to more efficiently utilize or design the space, structure, or size of the touch display device.

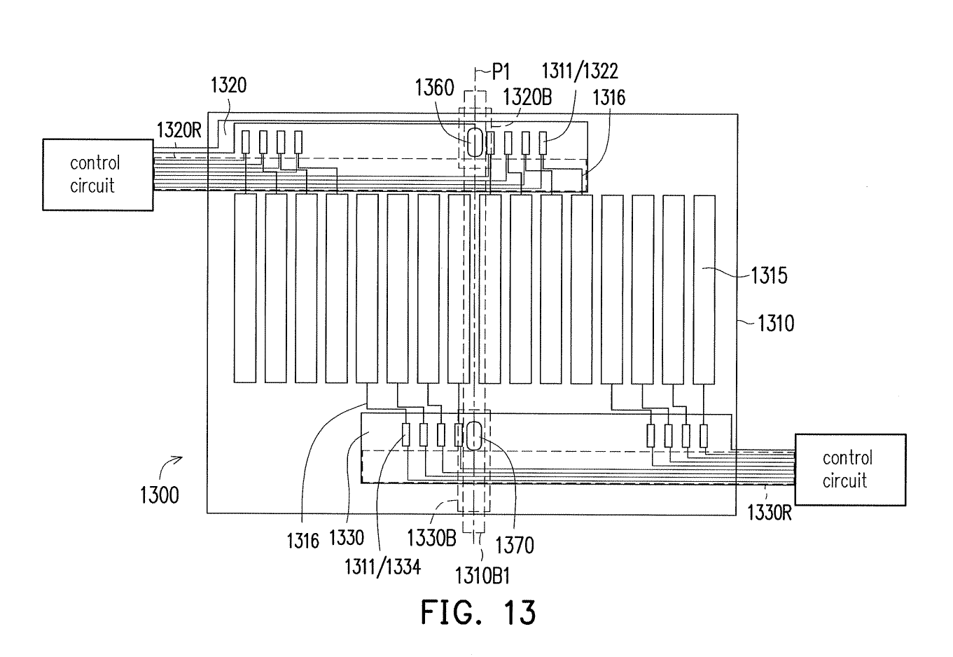

FIG. 13 is a schematic diagram illustrating a touch display device according to another embodiment. In the present embodiment, the touch display device 1300 includes a flexible touch display panel 1310 and flexible circuit boards 1320 and 1330. The flexible touch display panel 1310 includes first pads 1311, touch electrodes 1315, and conducting wires 1316. The flexible touch display panel 1310 has a first bending area 1310B1. The flexible touch display panel 1310 can be bent along a first bending axis P1. (FIG. 14 illustrates a scenario of the flexible touch display panel 1310 being bent).

In the present embodiment, the flexible circuit boards 1320, 1330 are disposed at opposite first and second sides of the flexible touch display panel 1310 respectively (a first side and a second side). The flexible circuit board 1320 has second pads 1322. The flexible circuit board 1330 has fourth pads 1334. At least a portion of the flexible circuit board 1320 is stacked on the flexible touch display panel 1310 to electrically couple the second pads 1322 of the flexible circuit board 1320 to a portion of the first pads 1311 of the flexible touch display panel 1310. At least a portion of the flexible circuit board 1330 is stacked on the flexible touch display panel 1310 to electrically couple the fourth pads 1334 of the flexible circuit board 1330 to another portion of the first pads 1311 of the flexible touch display panel 1310. Refer to the flexible circuit board 1020 of FIG. 10 and FIG. 12 for detailed explanations of the flexible circuit boards 1320 and 1330 of FIG. 13.

The flexible circuit boards 1320 and 1330 each respectively cross a first bending area 1310B1 of the flexible touch display panel 1310. The flexible circuit boards 1320 and 1330 respectively have bending areas 1320B and 1330B that are bent along a bending axis P1. At least a portion of the bending area 1320B of the flexible circuit board 1320 and at least a portion of the bending area 1330B of the flexible circuit boards 1330 are respectively stacked on the first bending area 1310B1 of the flexible touch display panel 1310. Accordingly, when the first bending area 1310B1 of the flexible touch display panel 1310 is bent, the bending areas 1320B and 1330B of the flexible circuit boards 1320 and 1330 are simultaneously bent along the first bending axis P1. Accordingly, touch signals of the touch electrodes 1315 of the flexible touch display panel 1310 can be transmitted to the control circuit through the flexible circuit boards 1320 and 1330. Accordingly, conducting wires 1316 of the flexible touch display panel 1310 are not disposed in the first bending area 1310B1 of the flexible touch display panel 1310, and as a result damage to the conducting wires 1316 due to bending of the flexible touch display panel 1310 can be prevented.

In the present embodiment, the second pads 1322 of the flexible circuit board 1320 and the first pads 1311 of the flexible touch display panel 1310 are electrically coupled by back-to-back bonding. The back-to-back bonding method is used to stack the wiring area 1320R of the flexible circuit board 1320 on the conducting wires 1316 of the flexible touch display panel 1310. Therefore, the flexible circuit board 1320 further includes an anti-magnetic layer (e.g. the anti-magnetic layer 1220C of FIG. 12). The anti-magnetic layer is disposed between the wiring area 1320R of the flexible circuit board 1320 and the conducting wires 1316 of the flexible touch display panel 1310, so as to prevent electromagnetic interference between the transmission conducting wires in the wiring area 1320R of the flexible circuit board 1320 and the conducting wires 1316 of the flexible touch display panel 1310.

The fourth pads 1334 of the flexible circuit board 1330 are electrically coupled to another portion of the first pads 1311 of the flexible touch display panel 1310 by face-to-face bonding. The face-to-face bonding method is used such that the wiring area 1330R of the flexible circuit board 1330 is not stacked on the conducting wires 1316 of the flexible touch display panel 1310.

More particularly, referring to FIG. 14. FIG. 14 illustrates a case of a bent flexible touch display panel 1310 according to the embodiment in FIG. 13. As shown in FIG. 14, in different cases, the flexible touch display panel 1310 of the touch display device 1300 can provide another touch display function after bending. For instance, the flexible touch display panel 1310 can operate in a tablet mode before the touch display device 1300 is bent, that is, the whole display/touch area of the flexible touch display panel 1310 is used as the touch display panel of a tablet computer. After the touch display device 1300 is bent, the flexible touch display panel 1310 can operate in a mobile phone mode or a handheld gaming mode.

In the present embodiment, sensors 1360 and 1370 are further disposed in the bending areas 1320B and 1330B of the flexible circuit boards 1320 and 1330. Detailed explanations of the sensors 1360 and 1370 of FIG. 13 can be deduced from the descriptions provided in FIG. 8 regarding the sensor 860. When the flexible touch display panel 1310 is bent in the bending area 1310B1, the sensors 1360 and 1370 provide sensing functions at a side area of the bent touch display device 1300 (as shown in FIG. 14). The sensors 1360 and 1370 can provide additional functions such as providing control functions by sensing changes in pressure, touch, or light. The invention does set a limit thereof. For instance, the touch display device 1300 of the present embodiment can provide the user with video viewing mode, and the sensors 1360 and 1370 can provide video control functions (e.g. play key, pause key, fast forward key, rewind key, volume key and/or other function keys). As another instance, the touch display device 1300 can allow the user to play games, and the sensors 1360 and 1370 can provide gaming functions (e.g. shoot key, acceleration key, a direction key, volume key and/or other function keys). However, the number of sensors and their disposition positions thereof are not limited to the above embodiments.

Additionally, in the embodiments, for details of the devices, and relationship of configuration of the flexible touch display panel, pads, touch electrodes, conducting wires, flexible circuit boards and sensors of FIGS. 13 and 14, refer to the related explanations in FIGS. 3 to 12 above which are not repeated herein. Moreover, the invention does not limit the number of flexible circuit boards or whether or not the first bending area of the flexible touch display is crossed in the present embodiment. The number of flexible circuit boards and the coupling relationship of the flexible touch display panels of the invention can adopt the combination, variations, or applications of the flexible circuit boards in the above embodiments.

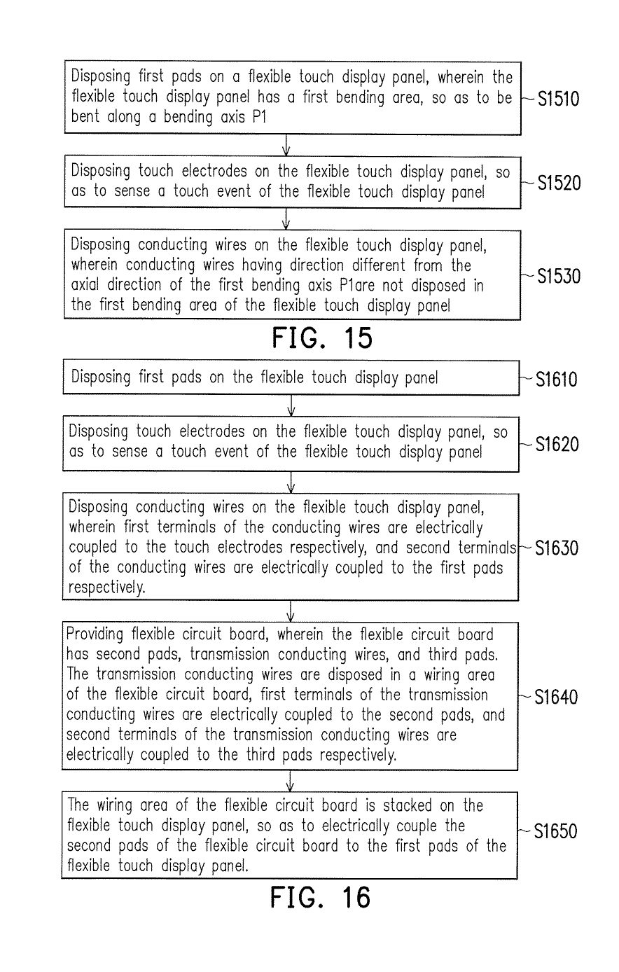

FIG. 15 is a flowchart of manufacturing method of touch display device illustrating a touch display device according to an embodiment. The manufacturing method of touch display device of the present embodiment is adapted for, for instance, at least the touch display device of FIG. 3. Referring to FIGS. 3 and 15. In step S1510, first pads 311 are disposed on a flexible touch display panel 310. Here the flexible touch display panel 310 has a first bending area 310B1 bending along a first bending axis P1. In step S1520, touch electrodes 351 are disposed on the flexible touch display panel 310 to sense a touch event of the flexible touch display panel 310. In step S1530, conducting wires 316 are disposed on the flexible touch display panel 310. Here, first terminals of the conducting wires 316 are electrically coupled to the touch electrodes 315 respectively, and second terminals of the conducting wires 316 are electrically coupled to the first pads 311 respectively. Here, any conducting wire having a direction different from the axial direction of the first bending axis P1 is not disposed in the first bending area 310B1 of the flexible touch display panel. Accordingly, a flexible touch display device can be manufactured based on the steps above, and the conducting wires disposed on the flexible touch display panel are not damaged as a result of bending of the flexible touch display panel.

FIG. 16 is manufacturing method flowchart illustrating a manufacturing method for touch display device according to another embodiment. The manufacturing method of touch display device of the present embodiment is adapted for, for instance, at least the touch display device of FIG. 10. Referring to FIGS. 10 and 16. In step S1610, first pads 1011 are disposed on the flexible touch display panel 1010. In step S1620, touch electrodes 1011 are disposed on the flexible touch display panel 1010 to sense a touch event of the flexible touch display panel 1010. In step S1630, conducting wires 1016 are disposed on the flexible touch display panel 1010, wherein first terminals of the conducting wires 1016 are electrically coupled to the touch electrodes 1015 respectively, and second terminals of the conducting wires 1016 are electrically coupled to the first pads 1011 respectively. In step S1640, a flexible circuit board 1020 is provided. Here, the flexible circuit board 1020 has second pads 1022, transmission conducting wires 1026, and third pads 1023. The conducting wires 1026 are disposed in a wiring area 1020R of the flexible circuit board 1020. The first terminals of the transmission conducting wires 1026 are electrically coupled to the second pads 1022, and the second terminals of the transmission conducting wires 1026 are electrically coupled to the third pads 1023 respectively. In step S1650, the wiring area 1020R of the flexible circuit board 1020 is stacked on the flexible touch display panel 1010 to electrically couple the second pads 1022 of the flexible circuit board 1020 to the first pads 1011 of the flexible touch display panel 1010. Accordingly, a flexible touch display device can be manufactured based on the steps above. Moreover, since the wiring area of the flexible circuit board is stacked on the flexible touch display panel, the space in the touch display device for flexible circuit board can be reduced.

In addition, the embodiments, details of the devices, and relationship of configuration of the flexible touch display panel, pads, touch electrodes, conducting wires, flexible circuit boards and sensors of FIGS. 15 and 16 are explained in the embodiments above and are not be repeated herein.

In view of the above, in some embodiments of the invention, via the configuration of conducting wires and pads on the flexible touch display, and relative position designs of the flexible circuit board, damage to the conducting wires on the flexible touch display panel can be prevented. In addition, some embodiments of the invention also provide methods of back-to-back electrical coupling of the flexible circuit board and the flexible touch display panel to reduce the space required for disposition of the flexible circuit board. Furthermore, in some of the embodiments, sensors are disposed in the bending area of the flexible circuit board to provide the touch display device with different operation modes of sensor functions after bending, and to provide a wider variety of operation methods.

Even though the invention is disclosed through the embodiments as above, the embodiments are not used to limit this invention, and any person with ordinary skill in the art, without deviating from the teachings and scope of this invention, may make adjustments and refinements; therefore, the scope of protection of this patent is defined as following claims.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch display device comprising:
a flexible touch display panel having a first bending area bending along a first bending axis;
a plurality of first pads disposed on the flexible touch display panel;
a plurality of touch electrodes disposed on the flexible touch display panel to sense a touch event of the flexible touch display panel; and
a plurality of conducting wires disposed on the flexible touch display panel, wherein a plurality of first terminals of the conducting wires is electrically coupled to the touch electrodes respectively, and a plurality of second terminals of the conducting wires is electrically coupled to the first pads respectively,
wherein a conducting wire having a direction different from an axial direction of the first bending axis is not disposed in the first bending area of the flexible touch display panel.

2. The touch display device of claim 1, wherein the first pads are not disposed in the first bending area.

3. The touch display device of claim 1, wherein the first bending area does not have a conducting wire.

4. The touch display device of claim 1, wherein the flexible touch display panel further has a second bending area bending along a second bending axis, wherein any conducting wire having a direction different from an axial direction of the second bending axis is not disposed in the second bending area of the flexible touch display panel.

5. The touch display device of claim 1, further comprising:
a flexible circuit board having a plurality of second pads and a plurality of third pads, wherein the third pads are electrically coupled to the second pads respectively, and at least one portion of the flexible circuit board is stacked on the flexible touch display panel to electrically couple the second pads of the flexible circuit board to the first pads of the flexible touch display panel respectively.

6. The touch display device of claim 5, wherein the flexible circuit board has a bending area, and the flexible circuit board crosses the first bending area of the flexible touch display panel when the flexible circuit board is stacked on the flexible touch display panel, such that the bending area of the flexible circuit board is also bent along the first bending axis when the flexible touch display panel is bent along the first bending axis.

7. The touch display device of claim 6, further comprising:
a sensor disposed on the flexible circuit board and located in the bending area.

8. The touch display device of claim 7, wherein the sensor comprises a force sensor, a touch sensor, or a light sensor.

9. The touch display device of claim 5, wherein the flexible circuit board has a plurality of transmission conducting wires, wherein the transmission conducting wires are disposed in a wiring area of the flexible circuit board, the first terminals of the transmission conducting wires are electrically coupled to the second pads respectively, and the second terminals of the transmission conducting wires are electrically coupled to the third pads respectively, wherein the wiring area of the flexible circuit board is stacked on the flexible touch display panel.

10. The touch display device of claim 9, wherein the flexible circuit board further comprises an anti-magnetic layer disposed between the flexible circuit board and the flexible touch display panel.

11. The touch display device of claim 1, further comprising:
a first flexible circuit board having a plurality of second pads and a plurality of third pads, wherein the third pads are electrically coupled to the second pads respectively, and at least a portion of the first flexible circuit board is stacked on the flexible touch display panel to electrically couple the second pads of the first flexible circuit board to a first pads group of the first pads of the flexible touch display panel respectively; and
a second flexible circuit board having a plurality of fourth pads and a plurality of fifth pads, wherein the fifth pads are electrically coupled to the fourth pads respectively, and at least a portion of the second flexible circuit board is stacked on the flexible touch display panel to electrically couple the fourth pads of the second flexible circuit board to a second pads group of the first pads of the flexible touch display panel respectively.

12. The touch display device of claim 11, wherein the first flexible circuit board and the second flexible circuit board do not cross the first bending area of the flexible touch display panel.

13. The touch display device of claim 11, wherein the first pads group and the second pads group of the first pads are disposed at a same side of the flexible touch display panel.

14. The touch display device of claim 11, wherein the first pads group of the first pads are disposed at a first side of the flexible touch display panel, and the second pads group of the first pads are disposed at a second side of the flexible touch display panel.

15. A touch display device comprising:
a flexible touch display panel having a plurality of first pads, a plurality of touch electrodes, and a plurality of conducting wires disposed on the flexible touch display panel, wherein the touch electrodes are configured to sense a touch event of the flexible touch display panel, wherein the first terminals of the conducting wires are electrically coupled to the touch electrodes respectively, and the second terminals of the conducting wires are electrically coupled to the first pads respectively; and
a flexible circuit board having a plurality of second pads, a plurality of transmission conducting wires, and a plurality of third pads disposed on the flexible circuit board, wherein at least a portion of the flexible circuit board is stacked on the flexible touch display panel to electrically couple the second pads of the flexible circuit board to the first pads of the flexible touch display panel respectively, wherein the transmission conducting wires are disposed in a wiring area of the flexible circuit board, the first terminals of the transmission conducting wires are electrically coupled to the second pads respectively, and the second terminals of the transmission conducting wires are electrically coupled to the third pads respectively, and wherein the wiring area of the flexible circuit board is stacked on the flexible touch display panel.

16. The touch display device of claim 15, further comprising an anti-magnetic layer disposed between the flexible circuit board and the flexible touch display panel.

17. A manufacturing method of touch display device, comprising:
disposing a plurality of first pads on a flexible touch display panel, wherein the flexible touch display panel has a first bending area bending along a first bending axis;
disposing a plurality of touch electrodes on the flexible touch display panel to sense a touch event of the flexible touch display panel; and
disposing a plurality of conducting wires on the flexible touch display panel, wherein a plurality of first terminals of the conducting wires is electrically coupled to the touch electrodes respectively, and a plurality of second terminals of the conducting wires is electrically coupled to the first pads respectively, wherein any conducting wire having a direction different from the axial direction of the first bending axis is not disposed in the first bending area of the flexible touch display panel.

18. The manufacturing method of claim 17, wherein the first pads are not disposed in the first bending area.

19. The manufacturing method of claim 17, wherein the first bending area does not have a conducting wire.

20. The manufacturing method of claim 17, wherein the flexible touch display panel further has a second bending area bending along a second bending axis, wherein any conducting wire having a direction different from an axial direction of the second bending axis is not disposed in the second bending area of the flexible touch display panel.

21. The manufacturing method of claim 17, further comprising:
providing a flexible circuit board, wherein the flexible circuit board has a plurality of second pads and a plurality of third pads, and the third pads are electrically coupled to the second pads respectively; and
stacking at least a portion of the flexible circuit board on the flexible touch display panel, so as to electrically couple the second pads of the flexible circuit board to the first pads of the flexible touch display panel respectively.

22. The manufacturing method of claim 21, wherein the flexible circuit board has a bending area, and the bending area of the flexible circuit board crosses the first bending area of the flexible touch display panel when the flexible circuit board is stacked on the flexible touch display panel.

23. The manufacturing method of claim 22, further comprising:
disposing a sensor on the flexible circuit board in the bending area.

24. The manufacturing method of claim 23, wherein the sensor comprises a force sensor, a touch sensor, or a light sensor.

25. The manufacturing method of claim 21, wherein the flexible circuit board has a plurality of transmission conducting wires disposed in a wiring area of the flexible circuit board, the first terminals of the transmission conducting wires are electrically coupled to the second pads respectively, and the second terminals of the transmission conducting wires are electrically coupled to the third pads respectively, wherein the wiring area of the flexible circuit board is stacked on the flexible touch display panel.

26. The manufacturing method of claim 25, further comprising:
disposing an anti-magnetic layer between the flexible circuit board and the flexible touch display panel.

27. The manufacturing method of claim 17, further comprising:
providing a first flexible circuit board, wherein the first flexible circuit board has a plurality of second pads and a plurality of third pads, and the third pads are electrically coupled to the second pads respectively;
stacking at least a portion of the first flexible circuit board on the flexible touch display panel to electrically couple the second pads of the first flexible circuit board to a first pads group of the first pads of the flexible touch display panel respectively;
providing a second flexible circuit board, wherein the second flexible circuit board has a plurality of fourth pads and a plurality of fifth pads, and the fifth pads are electrically coupled to the fourth pads respectively; and
stacking at least a portion of the second flexible circuit board on the flexible touch display panel to electrically couple the fourth pads of the second flexible circuit board to a second pads group of the first pads of the flexible touch display panel respectively.

28. The manufacturing method of claim 27, wherein the first flexible circuit board and the second flexible circuit board do not cross the first bending area of the flexible touch display panel.

29. The manufacturing method of claim 27, wherein the first pads group and the second pads group of the first pads are disposed at a same side of the flexible touch display panel.

30. The manufacturing method of claim 27, wherein the first pads group of the first pads are disposed at a first side of the flexible touch display panel, and the second pads group of the first pads are disposed at a second side of the flexible touch display panel.

31. A manufacturing method of touch display device, comprising:
disposing a plurality of first pads on a flexible touch display panel;
disposing a plurality of touch electrodes on the flexible touch display panel to sense a touch event of the flexible touch display panel;
disposing a plurality of conducting wires on the flexible touch display panel, wherein a plurality of first terminals of the conducting wires is electrically coupled to the touch electrodes respectively, and second terminals of the conducting wires are electrically coupled to the first pads respectively;
providing a flexible circuit board, wherein the flexible circuit board has a plurality of second pads, a plurality of transmission conducting wires, and a plurality of third pads, the transmission conducting wires are disposed on a wiring area of the flexible circuit board, the first terminals of the transmission conducting wires are electrically coupled to the second pads respectively, and the second terminals of the transmission conducting wires are electrically coupled to the third pads respectively; and
stacking the wiring area of the flexible circuit board on the flexible touch display panel to electrically couple the second pads of the flexible circuit board to the first pads of the flexible touch display panel respectively.

32. The manufacturing method of claim 31, further comprising:
disposing an anti-magnetic layer between the flexible circuit board and the flexible touch display panel.
